(19) United States
(12) Patent Application Publication
(10) Pub. No.: US 2003/0133370 A1
(43) Pub. Date: Jul. 17, 2003

(54) Method and reproducing apparatus for performing an actuator jump operation

(76) Inventor: Antonius Leonardus Johannes Dekker, Eindhoven (NL)

Correspondence Address: PHILIPS ELECTRONICS NORTH AMERICAN CORP, 580 WHITE PLAINS RD, TARRYTOWN, NY, 10591, US

(21) Appl. No.: 10/247,119

(22) Filed: Sep. 19, 2002

(30) Foreign Application Priority Data
Sep. 24, 2001 (EP) 01203606.7

(51) Int. Cl. G11B 7/085

(52) U.S. Cl. 369/30.16

(57) ABSTRACT

The present invention relates to a method and to a reproducing apparatus for performing an actuator jump operation so as to move a pick-up means (1) from one track to another track (the target track) over a number of tracks. A braking signal for stopping the movement of the pick-up means (1) is composed of a first component measured during a preceding velocity control period and used for maintaining the pick-up means (1) at a constant velocity and a second component for stopping the movement of the pick-up means (1) at the target track. The duration of an active brake period is the same for each braking action and the calculation of parameters for controlling a braking signal is simplified.

The present invention relates to a method of performing an actuator jump operation in response to a jump instruction so as to move a pick-up means, tracing a track on a record carrier, from one track to another track, said method comprising the steps of receiving a jump instruction, applying a jumping signal to initiate a movement of said pickup means, and applying a braking signal to stop said movement.

The invention further relates to a reproducing apparatus for reproducing information recorded on a record carrier, said apparatus comprising pick-up means for tracing a track on said record carrier, drive means for driving said pick-up means in a direction substantially perpendicular to said track, and actuator jump control means for applying a jumping signal and a braking signal to said drive means so as to move said pickup means to a different track.

A reproducing apparatus as described in the preamble comprises means for performing a tracking jump operation in response to a jump instruction so as to move a lens, mounted on a pick-up means, from one track to another track over a number of tracks. The reproducing apparatus may be any player or recorder for use with record carriers, such as an optical disc. Optical discs are, for example, CDs (Compact Discs), DVDs (Digital Versatile Discs), DVR (Digital Video Recording) carriers, or the like.

Information signals are recorded on the tracks of a disc or of another type of record carrier. In general, these tracks are arranged in a pattern of concentric circles, in a spiral shape, or in any other patterns leading to a neighboring arrangement of tracks. The information signals recorded on a disc are read by a reproducing apparatus comprising a pick-up unit that has a lens and is controlled to trace the tracks. An actuator of the pick-up unit is driven to control the lens of the pick-up unit. The pick-up unit reads the information signal by tracing the tracks. When the lens is to be moved to a required track, it traverses or jumps over a plurality of tracks. This operation is referred to as an actuator. When the lens is required to jump over tracks, the actuator controls the movement of the lens. For example, in an optical pick-up unit, a radiation beam is emitted and positioned by the lens to a required track on the disc so as to read the information signal by tracing the track. When the radiation beam is required to jump over several tracks, the actuator controls the position of the radiation beam emitted from a radiation source in the optical pick-up unit, such as, for example, a laser. When the radiation beam which traces a predetermined track under a tracking servocontrol is to jump to another track, a velocity control controls the velocity at which the lens is moved. The radiation beam thus starts to move laterally from a position on the current track towards a position on the destination track. When the radiation beam reaches a position on a border line of the destination track, the voltage applied to the tracking coil of the actuator is switched to a constant braking voltage which causes the actuator to perform a braking operation. Subsequently, the radiation beam stops its lateral movement when the light beam reaches a position on the destination track.

Braking the velocity of the actuator with a single brake pulse starting on a predetermined track requires a calculation of the duration and amplitude of the brake pulse. These calculations are rather complicated and, because of the varying pulse length, not linear when using an actuator having self-inductance. Document U.S. Pat. No. 5,481,517 discloses a method and reproducing apparatus as stated in the preamble. A “time-of-movement” measurement unit measures the movement time required for a radiation beam emitted from the optical pick-up to be moved across a track to a desired track. A voltage control unit subsequently uses the result of this measurement to generate parameters and a voltage value that are applied to the actuator.

It is in object of the present invention to provide a method and a reproducing apparatus for performing a track jump operation, by means of which the calculation of parameters for the track jump operation is simplified.

This object is achieved by a method as defined in claim 1 and by a reproducing apparatus as defined in claim 8.

Accordingly, by combining the first predetermined component for maintaining the velocity of the movement of the lens, measured during a preceding velocity control period, and the second predetermined component for stopping the movement of the lens at the desired track, the parameters for controlling the actuator jump operation can be calculated separately for the first and the second component which leads to a simplified calculation. The means for performing such a calculation can be less complex.

In a preferred embodiment, the braking operation comprises a first predetermined period in which the first predetermined component is applied and in which the second predetermined component is not applied, and a subsequent second predetermined period in which the second predetermined component and the first predetermined component are applied. A constant duration of the second predetermined period, which constitutes an active brake period, is thereby established, while the amplitude of the second predetermined component is controlled to achieve the required braking operation based on the velocity maintained during the first predetermined period.

Preferably, the first period is a delay period during which a constant velocity is maintained, and the second period is an active brake period having a constant duration. Due to the constant duration of the active brake period, the delay time and the amplitude of the braking signal can be calculated in a simple manner, and, moreover, non-linearities of the system can be reduced.

In a further embodiment, the braking operation is performed during a brake period starting at the last track crossing, detected by the tracking error zero crossing, before the transition corresponding to the other track.

In an advantageous embodiment of the invention, a tracking integration function used for tracking control of the pick-up means is controlled during the preceding velocity control period so as to measure and store the velocity preceding the first predetermined component and, during the second predetermined period, to combine the measured preceding control value to the second predetermined component. The tracking integration function is thereby adapted to perform the two-step track jump procedure, such that circuit modifications required for implementing the invention are minimized.

Furthermore, the duration between the end of the braking signal and the first crossing of the other track can be determined and used for calibrating the amplitude of the braking signal. The second predetermined component can thereby be adapted according to any detected brake mismatch, so as to achieve an adaptive track jump operation.

The tracking integration function can be provided by an integrator means, which, for example, comprises a register means for storing the measured first predetermined component, and switching means for combining the measured control value preceding the brake operation to the second predetermined component, wherein the switching means are controlled by the actuator jump control means.

The reproducing apparatus may be any player or recorder for record carriers such as CDs (Compact Discs), DVDs (Digital Versatile Discs), DVR (Digital Video Recording) carriers, or the like.

In the following, the present invention will be described in greater detail on the basis of a preferred embodiment with reference to the accompanying Figures, in which:

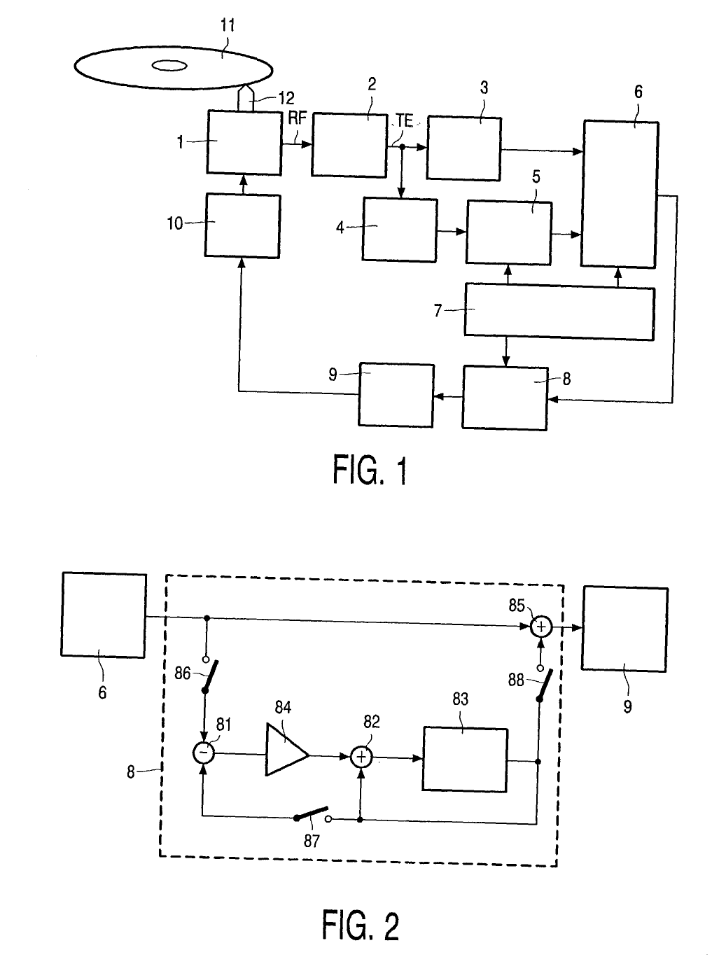

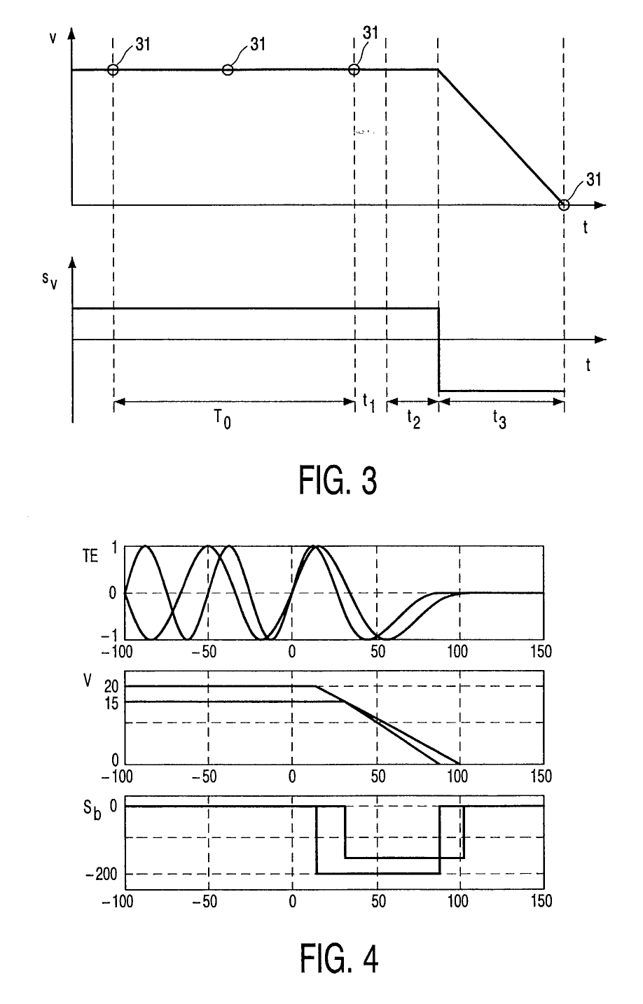

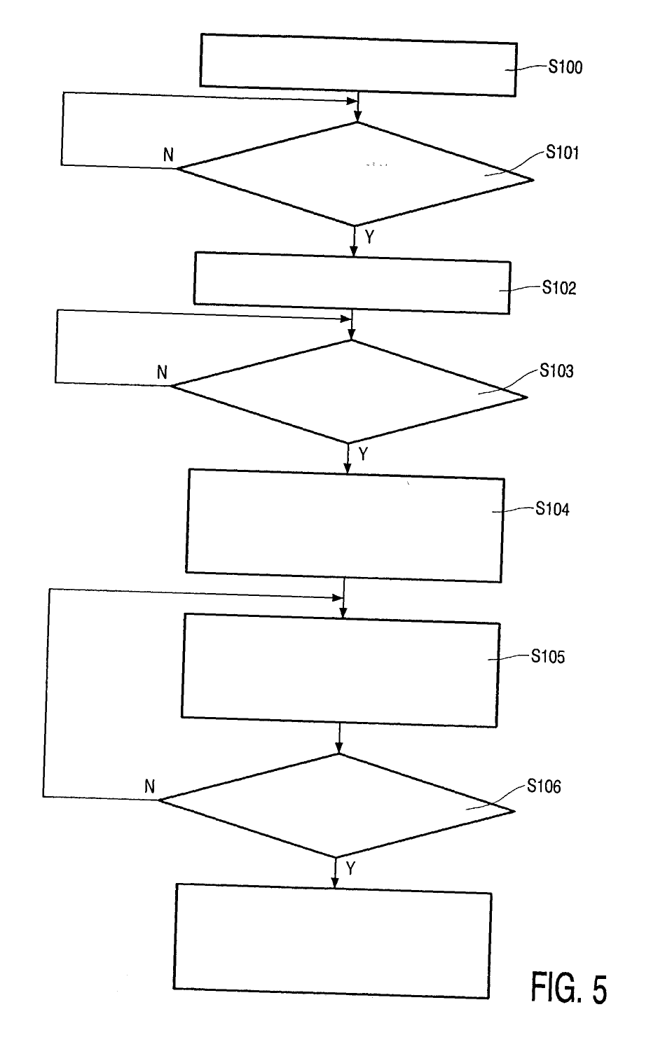

FIG. 1 is a block diagram of a reproducing apparatus according to a preferred embodiment of the present invention, FIG. 2 is a functional block diagram of an integrator provided in a reproducing apparatus according to the present invention, FIG. 3 shows diagrams indicating a braking signal and a corresponding change of velocity of a pick-up unit, FIG. 4 shows diagrams indicating a tracking error signal, a velocity change, and a signal comprising brake pulses in accordance with two brake pulse examples, and FIG. 5 is a flow chart of an actuator jump operation in accordance with a preferred embodiment.

A preferred embodiment will now be described on the basis of an optical disc player as shown in FIG. 1. The optical disc player comprises an optical pick-up unit 1 which applies a radiation beam 12, such as a laser light beam, to an optical disc 11, thus projecting a laser light spot on the optical disc. The laser light spot is reflected by the optical disc and the reflected laser light returns to the optical pick-up unit 1. The optical pick-up unit 1 outputs an RF signal in response to the returned laser light. A tracking error detection unit 2 outputs a tracking error signal TE in response to the RF signal. This tracking error signal TE may be obtained on the basis of an extraction and comparison of an envelope signal of the RF signal. Alternatively, the tracking error signal TE might be detected by a push-pull method, a DPD method or by using two satellite beams. Subsequently, the tracking error signal TE is supplied to a zero-cross detector 4 which outputs a zero-cross signal indicating that the tracking error signal TE crosses the zero point.

When a controller 7 outputs an actuator jump instruction to a jump controller 5, a velocity control function of the jump controller 5 controls a lens in the pick-up unit 1 with a certain velocity profile which is constant approaching the braking operation. The control value from the velocity control function is passed through a switch 6, which is controlled by the controller 7, and is supplied to an integrator 8. The integrator 8 supplies a control signal to a drive circuit 9 which is arranged to drive a tracking actuator 10 in response to the control value, so that the tracking actuator 10 controls the lens in the pick-up unit 1.

The drive circuit 9 initiates a braking operation in response to the control signal supplied by integrator 8, thereby stopping the movement of the laser beam 12 of the pick-up unit 1 at the target track. At the start of the jump operation, the level of the tracking error signal TE initially increases from a zero level. Subsequently, it increases and decreases along a sinusoidal curve and crosses the zero level. This change in the level of the tracking error signal TE indicates that the laser beam moves from one track to a neighboring track. The crossing of the zero level is detected by the zero-cross detector 4 which outputs the zero-cross signals in response to each zero level crossing. The output signal of the zero-cross detector 4 is supplied to the jump controller 5 which controls the jump operation in response to the zero-cross signals received from the zero-cross detector 4.

In particular, the actuator jump operation may comprise the following four periods controlled by the jump controller 5. In a first period, the jump operation starts with a velocity control based on a predetermined speed profile, wherein the velocity or speed is reduced when the target track is approached. A number of tracks before the target track, when the velocity controlled in the first period has reached a predetermined value, a second period starts. In this second period, the velocity set point of the velocity control is kept constant at its predetermined value. A third period in which a predetermined delay period is started, is initiated one track before the target track. This predetermined delay period is calculated in dependence on the constant velocity of the second period. When the predetermined delay period has expired, a fourth period starts. In this fourth period, an additional braking value is added to the output signal of the drive circuit 9. The amplitude of the output signal of the drive circuit 9 is determined in dependence on the constant velocity of the second period. After these four periods, the tracking control loop is switched on again by controlling the switch 6.

Jump controller 5 has different functions depending on the four aforementioned periods. During the first and the second period, the jump controller 5 provides a velocity control function, while it outputs an adaptive brake pulse during the fourth period.

Switch 6 is controlled by the controller 7 such that, during a normal information reproducing process, a phase compensation circuit 3 is coupled, through the integrator 8, to the drive circuit 9 so as to execute a tracking servocontrol by correspondingly driving the tracking actuator 10. Low-frequency components and steady-state errors are thereby reduced. The tracking servocontrol is performed on the basis of the tracking error signal TE which is also supplied to the phase compensation circuit 3 which determines the tracking loop gain. The lens is thereby controlled by the actuator 10 so as to keep the spot of the laser light beam 12 within a track line part during the normal information reproducing operation.

Hence, the braking signal generated by the jump controller 5 is composed of three components. A first component is provided to perform a velocity control in accordance with a predetermined speed profile until a predetermined constant velocity is reached. A second component is adapted to maintain the movement of the lens, and thereby the movement of the laser light beam in relation to the tracks, at the constant velocity. A third component is adapted to stop the movement of the pick-up unit 1, and therefore of the laser light beam, within a distance corresponding to a single track.

In particular, a jump operation comprises a first step in which the value of the third component is zero and in which the value of the second component is controlled to maintain the velocity of the pick-up operation. The jump operation further comprises a second step in which the third component is combined to the second component so as to stop the movement within one track.

When a jump is performed over a number of tracks, the velocity of the pick-up during the jump can be measured in the zero-cross detector 4 or, alternatively, in the jump controller 5. In particular, a predetermined constant velocity during the aforementioned second period can be controlled by sampling the track crossings. As an example, a timer may be provided for measuring the time interval between a predetermined number of track crossings preceding the target track. This time interval can then be used by the jump controller 5 to determine the velocity of the pick-up and to calculate the components of the braking signal.

Because of the separation of the braking signal into the first to third component, the same duration of the second step can be provided for each braking action. The calculation of the parameters for controlling the second and the third component, that is the duration of the first step, and the value or amplitude of the third component can thereby be simplified. Moreover, non-linearities can be reduced due to the constant duration of the active brake period.

According to an preferred embodiment, the actual brake period starts after the velocity control (first component), at the last positive transition of the tracking error signal TE before the transition corresponding to the target track. The brake period comprises the predetermined delay period during which the braking signal is maintained at a signal value required by the actuator 10 to maintain the speed of the jump movement. During this delay period, no brake pulse is generated by the jump controller 5 so as to maintain a constant velocity. After the delay period, an active brake period comprising a brake pulse of a constant duration is initiated. The amplitude of this brake pulse is selected so as to reduce the maintained velocity to zero within one track. An adaptive control of the actuator jump operation can thereby be provided while the processing requirements for calculating the parameters are reduced.

FIG. 2 is a functional block diagram of an integrator 8 which is adapted to combine the three components of the jump procedure. The integrator 8 comprises a first switching function or switch 86, a second switching function or switch 87, and a third switching function or switch 88, all of which may be implemented by any physical or electronic switching device which can be controlled by the controller 7. During the usual tracking servocontrol operation, the first switch 86 and the second switch 88 are closed, while the third switch 87 is opened. The integrator 8 thereby operates as an active PID-integrator comprising an amplifier 84, a first adder circuit 82, a register 83 in which the control signal or control data is accumulated to achieve the integration function, and a second adder circuit 85. Thus, register 83 adds its output to the signal outputted by switch 6 and the resulting signal is supplied to the drive circuit 9. The circuitry around register 83 is configured to serve as an integrator controlled by a control signal supplied from the controller 7.

During the first and the second period of the jump operation, the controller 7 controls the switches 86, 87 and 88 of the integrator 8 such that the first switch 86 and the third switch 87 are closed and the second switch 88 is open. Thus, the control value received from the jump controller 5 through switch 6 is measured, filtered and stored in the register 83 of the integrator 8. The register 83 is thereby switched in a low-pass filter configuration to measure the quasi-stationary control value supplied to the drive circuit 9. During the second period, the output of the register 83 will become equal to the control value required to keep the velocity of the lens of the pick-up unit 1 at a constant value. In the third period, the output of the register 83 is switched by the switch 88 to the drive circuit 9 so as to keep the velocity unchanged. Subsequently, when the fourth period (that is, the active brake period) starts, the measured value for maintaining the velocity is added by the second adder circuit 85 to the generated brake pulse so as to obtain a braking signal composed of two components, that is, the aforementioned second and third components. The individual generation of the two braking signal components allows an individual calculation of the duration of the delay period and of the amplitude of the brake pulse. It is noted that the function of the integrator 8 may, for example, be implemented by any other kind of programmable signal processing device such as a program-controlled signal processor.

FIG. 3 shows a graph indicating the velocity change of the lens in the pick-up unit 1 (the upper graph in FIG. 3) and a graph indicating the braking signal according to an preferred embodiment (the lower graph in FIG. 3). In the velocity graph, the circles 31 positioned on the velocity curve indicate zero-crossings of the tracking error signal. The time duration between two positive transitions (that is, two times the time duration between two subsequent zero-crossings) is denoted by T₀, which is a value required for calculating the delay period (t₂) and the amplitude of the brake pulse. T₀ occurs in the last phase of the aforementioned second period of the jump operation. Next, a period t₁ indicates an inherent delay between the detection of the zero-crossing by the zero-cross detector 4 and the output of the control value by the jump controller 5. A delay period t₂ follows during which the value or the amplitude of the braking signal is selected so as to maintain a constant velocity of the laser beam jump movement. Thus, the period t₂ corresponds to the aforementioned third period of the jump operation. Subsequently, a control value for generating the actual brake pulse is generated by the jump controller 5 and added to the value in the integrator 8 for maintaining the constant velocity. The duration of the delay period and of the amplitude of the brake pulse during the constant duration t₃ are selected in such a way that the velocity of the laser beam movement reaches zero within one track. The constant duration t₃, which corresponds to the aforementioned fourth period of the jump operation, is determined by the inherent delay of the control loop, the actuator sensitivity, the maximum control voltage, the disc speed and eccentricity, and the track pitch. The velocity is thereby zero at that zero-crossing of the tracking error signal which corresponds to the target track.

The duration of the delay period is calculated in accordance with the following equation

t₂=1/2·(T₀−t₃−t₁),

wherein t₁ is subtracted as a delay compensation value for compensating the inherent delay of the system. Furthermore, the amplitude s_{b} of the brake pulse is calculated in accordance with the following equation:

s_{b}=K/T₀,

wherein K is a value depending on the physical implementation of the system and is obtained experimentally so as to achieve the velocity reduction to zero within the constant duration t₃ of the brake pulse.

FIG. 4 shows graphs indicating the signal flows of the tracking error signal TE (the upper graph in FIG. 4), the velocity v (the middle graph in FIG. 4) and the brake pulse s_{b} (the lower graph in FIG. 4) for two brake pulse examples. According to the first example, a higher constant velocity (e.g. 20 tracks per second) is maintained, such that a lower delay period and a higher brake pulse amplitude are obtained due to the smaller value of T₀. In the second example, a lower constant velocity is maintained (e.g. 15 tracks per second), wherein a longer delay period t₂ and a lower brake pulse amplitude s_{b} is obtained due to the greater value of T₀.

FIG. 5 is a flow chart of the actuator jump operation according to a preferred embodiment. In step S100, the jump controller 5 performs a velocity control in accordance with a predetermined speed profile. Next, in step S101, a check is performed as to whether the third positive transition before the target track has been reached. This check is based on the zero-cross detection output of the zero-cross detector 4. In step S101, the check is repeatedly performed until the third positive transition has been detected. Upon detection thereof, the operation proceeds to step S102 in which timer means or counter means are started for obtaining T₀. For this purpose, the zero-cross detector 4 is, for example, adapted to measure the time interval T₀ between two positive zero-crossings of the track error signal TE. After the measurement of T₀ in step S102 has been started, the operation proceeds to step S103 where a check is performed, by the jump controller 5, as to whether the last positive transition has been reached. This check is based on the zero-cross detection output of the zero-cross detector 4. In step S103, the check is repeatedly performed until the last positive transition before the target track has been detected. Immediately upon detection thereof, step S104 is executed in which the timer value, or the counter value, is read out and the value of T₀ is obtained. The delay period t₂ and the brake pulse amplitude s_{b} are calculated by the jump controller 5, for example based on a jump velocity determined on the basis of preceding zero crossings of the tracking error signal TE, while the velocity is maintained at a constant value and the corresponding control value is measured and stored in the register 83 of the integrator 8. The calculations are performed in accordance with the aforementioned two equations. Next, in step S105, the controller 7 supplies a control signal to the integrator 8 to apply the measured control output stored in the register 83 to the drive circuit 9 so as to maintain the velocity of the lens in the pick-up unit 1. Also a timer or counter function of the jump controller 5 counts the delay period t₂. Subsequently, in step S106, the jump controller 5 determines whether the delay period t₂ of the braking signal has expired. If not, the control value for maintaining the velocity is kept applied and no additional control value is supplied by the jump controller 5 to the integrator 8. If the delay period t₂ has expired, the jump controller 5 generates in step S107 the additional control value for the brake pulse, with the constant duration t₃ and the calculated amplitude s_{b}, to which the measured control output is added in the integrator 8 to obtain the combined braking signal.

It is noted that the present invention is not limited to the preferred embodiments described above. It can be applied to any reproducing apparatus having an actuator jump function for moving a pick-up unit over a number of tracks to a target track. Moreover, any braking signal may be generated having a first component, for maintaining the pick-up function at a constant velocity, and a second component, for stopping the movement of the pick-up function within a single predetermined number of tracks. Thus, the invention is intended to cover any modifications within the scope of the appendant claims.

1. A method of performing an actuator jump operation in response to a jump instruction so as to move a pick-up means (1), tracing a track on a record carrier, from one track to another track, said method comprising the steps of
a) receiving a jump instruction,
b) applying a jumping signal to initiate a movement of said pick-up means (1), and
c) applying a braking signal to stop said movement,
characterized in that the method comprises the further steps of
d) measuring a first predetermined component of said braking signal during a preceding velocity control period, and
e) generating said braking signal by combining said measured first predetermined component for maintaining the velocity of said movement of said pick-up means, and a second predetermined component for stopping said movement of said pick-up means at said other track.

2. A method as claimed in claim 1, characterized in that said braking signal comprises a first predetermined period in which said first predetermined component is applied and in which said second predetermined component is not applied, and a subsequent second predetermined period in which said first predetermined component and said second predetermined component are applied.

3. A method as claimed in claim 1 or 2, characterized in that said braking signal comprises a first predetermined period in which said first predetermined component is applied and in that the first predetermined period is adapted to start at the last positive transition of a tracking error signal before the transition corresponding to said other track.

4. A method as claimed in claim 2, characterized in that said first predetermined period is a delay period (t₂) in which said velocity is maintained constant and said second period is an active brake period having a constant duration.

5. A method as claimed in claim 2 or 4, characterized in that the duration of said first predetermined period is determined in accordance with to the equation:
t₂=1/2·(T₀−t₃−t₁),
wherein T₀ denotes the duration between two positive transitions of a tracking error signal, t₁ denotes a delay compensation parameter, t₂ denotes the duration of said first predetermined period, and t₃ denotes the duration of said second predetermined period.

6. A method as claimed in claim 2, 4 or 5, characterized in that said second predetermined component is a brake pulse, wherein the amplitude of said brake pulse is determined in accordance with to the equation:
s_{b}=K/T₀,
wherein K is a predetermined constant value, T₀ denotes the duration between two positive transitions of a tracking error signal, and s_{b} denotes the amplitude of said brake pulse.

7. A method as claimed in claim 2, 4, 5, or 6, characterized by controlling a tracking integrator function during said velocity control period preceding said first period so as to measure and store said first predetermined component, during said first predetermined period to output said measured first predetermined component, and during said second predetermined period to combine and output said measured first predetermined component and said second predetermined component.

8. A reproducing apparatus for reproducing information recorded on a record carrier, said apparatus comprising
a) pick-up means (1) for tracing a track on said record carrier,
b) drive means (9, 10) for driving said pick-up means (1) in a direction substantially perpendicular to said track, and
c) actuator jump control means (5, 7) for applying a jumping signal and a braking signal to said drive means (9) so as to move said pick-up means (1) to another track,
characterized in that the apparatus further comprises
d) measuring means (8) for measuring a first predetermined component of said braking signal during a preceding velocity control period, and
e) said actuator jump control means comprises signal generating means (5) for generating said braking signal by combining said measured first predetermined component for maintaining the velocity of said movement of said pick-up means (1) and a second predetermined component for stopping said movement of said pick-up means (1) at said other track.

9. An apparatus as claimed in claim 8, characterized in that said signal generating means (5) is arranged to generate said braking signal in such a manner that, during a first predetermined period, said first predetermined component is applied and said second predetermined component is not applied, and such that, during a subsequent second predetermined period, said first predetermined component and said second predetermined component are applied.

10 An apparatus as claimed in claim 9, characterized in that said measuring means comprises integrator means (8) for measuring and storing said first predetermined component during said velocity control period, for outputting said measured first predetermined component during said first predetermined period, and for combining and outputting said measured first predetermined component and said second predetermined component during said second predetermined period.

11. An apparatus as claimed in claim 10, characterized in that said integrator means (8) comprises register means (83) for storing said measured first predetermined component, and switching means (88) for combining said measured first predetermined component to said second predetermined component, wherein said switching means (88) is controlled by said actuator jump control means (5, 7).

12. An apparatus as claimed in claim 8, characterized in that the apparatus comprises means for executing a method as claimed in any one of claims 1 to 7.

13 An apparatus as claimed in any one of claims 8 to 12, characterized in that said reproducing apparatus is an optical disc player or an optical disc recorder.
